(19) United States
(12) Patent Application Publication
(10) Pub. No.: US 2016/0027549 A1
(43) Pub. Date: Jan. 28, 2016

(54) RESISTANCE COVERING FOR A DC INSULATION SYSTEM

(71) Applicant: SIEMENS ANKTIENGESELLSCHAFT, München (DE)

(72) Inventor: Steffen LANG, Hallerndorf (DE)

(73) Assignee: SIEMENS AKTIENGESELLSCHAFT, Munich (DE)

(21) Appl. No.: 14/772,965

(22) PCT Filed: Jan. 15, 2014
(86) PCT No.: PCT/EP2014/050713

§ 371 Date: Sep. 4, 2015

(30) Foreign Application Priority Data
Mar. 18, 2013 (DE) 10 2013 204 706.1

(51) Int. Cl. H01B 3/10; C08K 3/04; C08K 3/34; C08K 3/22; H01B 3/04; H01B 3/02

(52) U.S. Cl. CPC H01B 3/10; H01B 3/04; H01B 3/02; C08K 3/34; C08K 3/22; C08K 3/04; C08K 2003/045

(57) ABSTRACT

A resistance covering for a DC insulation system may be a matrix material with particles embedded therein, the particles having an aspect ratio greater than 1. The matrix material is flexible to such an extent that the particles align depending on an electric field strength. The particles can align in the electric field and thus a breakdown voltage of the resistance covering is increased. A DC insulation system may have the resistance covering.

### CROSS REFERENCE TO RELATED APPLICATIONS

This application is based on and hereby claims priority to International Application No. PCT/EP2014/050713 filed on Jan. 15, 2014 and German Application No. 10 2013 204 706.1 filed on Mar. 18, 2013, both applications are incorporated by reference herein in their entirety.

### BACKGROUND

Described below is a resistance covering for a DC insulation system. Also described below is a DC insulation system having the resistance covering.

Insulation systems for DC applications are usually based on a gaseous or a solid dielectric material. If DC voltage is applied to these insulation systems and they are subjected to a stationary electrical field, the electrical field distribution is solely determined by the resistive properties of the insulation system. The surface resistance of the dielectric material is predominantly decisive for the resistive properties. If the insulation system is under the influence of a rectified electrical field, a charge carrier accumulation forms at the interface between solid dielectric material and gaseous dielectric material. In this case, the charge carrier accumulation can also be induced by dirt particles on the surface of the dielectric material. The field distribution on the surface of the dielectric material is thus negatively influenced, so that local excessive field increases occur, which can result in flashovers. A conductive surface of the dielectric material, for example, in the form of a conductive resistance covering, can dissipate these charge carrier accumulations and thus avoid an excessive field increase.

More recent developments require the electrical installations to be designed more and more compactly in low-voltage, moderate-voltage, and high-voltage technology. Higher and higher field strengths occur in this case due to the smaller and smaller distances between the conductors. From a field strength of 30 V/mm, however, nonlinear effects can occur in the conductive resistance covering, and the current density no longer increases linearly with the field strength. The resistance covering then no longer has ohmic behavior. The excessively elevated current density results in this case in heating and, in the worst case, in overheating of the resistance covering, which can thus be damaged.

### SUMMARY

In one aspect, an improved resistance covering is provided that also has ohmic behavior at high field strengths of greater than 30 V/mm and is usable for various applications.

A resistance covering for a DC insulation system is proposed, formed of a matrix material having particles embedded therein, which have an aspect ratio greater than 1. In this case, the matrix material has a flexible nature such that the particles align themselves in dependence on an electrical field strength.

The aspect ratio may be greater than 2 and may be greater than 15. The aspect ratio means the ratio between an extension of a particle in a first spatial direction and an extension of the particle in a second spatial direction here. In particular, particles having an aspect ratio greater than 1, greater than 2, or even greater than 15, have a preferential direction, along which they align.

If the particles can align themselves in the matrix material of the resistance covering in dependence on the electrical field strength, an ohmic behavior of the resistance covering can be ensured or maintained at high field strengths of, for example, greater than 30 V/mm, greater than 100 V/mm, or even greater than 500 V/mm. “Ohmic behavior” means that the current density of the resistance covering increases linearly with the electrical field strength. Conduction effects between the particles are responsible for the ohmic behavior of the proposed resistance covering.

Thus, the grain boundaries in the individual particles and the particle transitions form potential barriers, which cannot be tunneled through below the breakdown voltage. The conduction mechanism in this range results from a leakage current between the particles, which can be described, for example, with the aid of the Pool-Frenkel effect or the Richardson-Schottky mechanism.

At high voltages greater than the breakdown voltage, the electrons can overcome the potential barrier and the current density within the resistance covering increases disproportionally to the field strength. This nonlinear, in particular exponential behavior of the current density can be characterized with the aid of the nonlinearity exponents “alpha” and the breakdown voltage. The breakdown voltage refers in this case to the voltage from which the electrons can overcome the potential barriers at the grain boundaries and particle transitions, and conduction begins between the particles. The breakdown voltage is therefore proportional to the number of the particles, and therefore the potential barriers of the grain boundaries and particle transitions. Therefore, if the field strength increases enough that the breakdown voltage is exceeded, the electrons can tunnel between the individual particles and the current density of the resistance covering no longer increases linearly and in particular exponentially. The nonlinearity exponent is defined in this case by the slope of the respective logarithmically plotted current density-field strength characteristic curve. In the case of a linear, ohmic characteristic curve, “alpha” has the value 1. In the case of a nonlinear resistance behavior, “alpha” is greater than 1.

In the event of rising field strengths, additional charges can be displaced within the particle and the particles become polarized. If the matrix material is sufficiently flexible that the particles can move, they align themselves in relation to one another in accordance with the polarization thereof. In this case, the spacing and, as a result, also the potential barrier between individual particles is increased. The breakdown voltage shifts toward higher field strengths, and the resistance covering also has an ohmic behavior at voltages greater than the original breakdown voltage. An ohmic resistance behavior can therefore also be guaranteed using the resistance covering at high voltages or field strengths, and it can be ensured that the resulting current density does not increase disproportionally, but rather only linearly, even at high field strengths. It can thus in turn be ensured that the power loss resulting from the current density also only increases linearly with increasing field strength, whereby the resulting Joule heating, which is proportional to the power loss, also does not increase disproportionally. The resistance covering is thus not subjected to an impermissibly high temperature and, as a result thereof, is not thermally destroyed. Therefore, an electrical charge at interfaces, for example, between a solid and a gaseous dielectric material, can thus be dissipated by the resistance covering, without having to take design measures, which occupy a large amount of space, and it can be ensured at the same time that the resistance covering does not become impermissibly hot.

In the present case, “resistance covering” also means a resistance layer. It can, but does not have to be formed in an integrally joined manner with an insulator or another component.

The resistance covering can be used in various DC insulation systems having field strengths greater than 30 V/mm, greater than 100 V/mm, or even greater than 500 V/mm. For example, the resistance covering can be used in high-voltage direct-current transmission (HVDC) or in high-voltage direct-current insulation systems, such as transformers and the feedthroughs thereof. The use in electronic components in which high field strengths occur, for example, in printed circuit boards, is also possible. Thus, in particular in the case of printed circuit boards of semiconductor technology, for example, in processors or chips, field strengths greater than 30 V/mm, greater than 100 V/mm, or even greater than 500 V/mm occur if conductors are arranged at a small distance to one another due to the miniaturization.

In one embodiment, the matrix material is an elastomer for the required flexibility of the matrix material. The elastomer has a glass transition temperature which is less than an intended usage temperature of the resistance covering. A usage temperature range refers here to the temperatures which can occur in operation in the component equipped with the resistance covering. The usage temperature range thus covers the temperatures to which the resistance covering can be subjected. For example, the matrix material can be elastic in a usage temperature range of −200 to 500° C., such as from −20 to 120° C., or from 40 to 70° C. The glass transition temperature may be less than the lower limit of the usage temperature range. The resistance covering can accordingly be designed for a usage temperature range of −200 to 500° C., such as −20 to 120° C., or 40 to 70° C.

In a further embodiment, the matrix material is designed to be elastic. The matrix material of the resistance covering may be selected so that it is elastic at the intended usage temperatures. The particles can therefore move in the matrix material and align themselves in dependence on the field strength. After the electrical field is removed, the particles resume the original orientation thereof.

A variety of elastomers are suitable as the matrix material. Rubbers are mentioned here as examples, such as natural rubber (NR), acrylonitrile-butadiene rubber (NBR), styrene-butadiene rubber (SBR), chloroprene rubber (CR), butadiene rubber (BR), and ethylene-propylene-diene rubber (EPDM), or poly(organo)siloxane rubber (silicone rubber). Further elastomers mentioned as examples are resins, such as polymethyl siloxane resin, polymethyl phenyl siloxane resin, epoxy resin, alkyd resin, or polyester imide resin. The matrix material can also contain a mixture having various elastomers.

In a further embodiment, the matrix material has a Shore hardness A of 10 to 90, such as 20 to 80, or 30 to 50. In this case, the Shore hardness relates to the matrix material without embedded particles. The matrix material can furthermore have a loss modulus G″ which is less than a storage modulus G′.

Rubbers, such as silicone rubber, are more elastic than resins, such as polyester imide resin. Thus, the Shore hardnesses A of silicone rubbers are in the range of 35 to 50. In contrast, elastic polyester imide resins have a Shore hardness A greater than 45, in particular between 50 and 80, for example, between 60 and 80. The elasticity of the matrix material influences in this case how rapidly the particles align themselves in the event of changing field strength or how rapidly the particles relax, i.e., return to the starting position thereof. Thus, the particles can immediately align themselves with the rising field strength in a silicone rubber, for example, while particles in a polyester imide resin, for example, align themselves with the rising field strength with a time delay, or, if the matrix is sufficiently stiff, do not align themselves at all. Analogously thereto, particles relax faster in the silicone rubber, for example, than in the polyester imide resin, for example.

In a further embodiment, the particles are in the form of small plates or small rods. Particle mixtures having a mixture made of particles in the form of small plates and particles in the form of small rods are also possible. In this case, the particles can have an aspect ratio of 10 to 1000, such as 10 to 100, or 15 to 50. The aspect ratio refers to the ratio in each case of length and width to thickness for particles in the form of small plates. In the case of particles in the form of small rods, the aspect ratio refers to the ratio in each case of width and thickness to length. In this case, the aspect ratio and the asymmetry resulting therefrom in the particle dimensions influence the tendency of the particles to align themselves. Thus, particles having a large aspect ratio have a greater tendency to align themselves than particles having a smaller aspect ratio. In the case of particles in the form of small plates, for example, the particles align themselves in the resistance covering along the largest surface, i.e., the largest surface is oriented in parallel to an interface between, for example, a solid and a gaseous dielectric material. Similarly, particles in the form of small rods can align themselves along the length, i.e., the largest axis is oriented in parallel to an interface between, for example, a solid and a gaseous dielectric material.

In a further embodiment, the particles contain mica particles, silicon carbide particles (SiC particles), metal oxide particles, in particular aluminum oxide particles (Al₂O₃ particles), carbon nanotubes, or mixtures thereof. These particles are available in particular in the above-mentioned aspect ratios.

In a further embodiment, a volume fraction of the particles is between 5 and 55 vol. %, such as between 6.5 and 40 vol. %, or between 15 and 30 vol. %. In this case, the volume fraction and specifications in vol. % refer to the total volume of the matrix material and the particles. These volume fractions of particles correspond, in the case of a matrix material having a density of 1 g/cm³ and particles in the form of small plates having a density of 3.5 g/cm³, to an aspect ratio of 20. If the particle fraction is excessively high, the movement clearances of the individual particles are restricted and they can no longer align themselves in the matrix material. Therefore, the particle fraction is selected so that the particles can align themselves in the matrix material. If the particle fraction is excessively low, the particles cannot contact one another, whereby no conduction paths are formed and the resistance covering has the specific resistance of the matrix.

In a further embodiment, a volume fraction and/or aspect ratio of the particles is selected so that the percolation threshold is exceeded. In this case, the percolation threshold refers to the volume fraction of particles, in the case of which, if it is exceeded, the particles contact one another and can form conductive paths in the matrix material. In this case, the volume fraction at which the percolation threshold is exceeded can be dependent on the aspect ratio of the particles.

In a further embodiment, the matrix material contains first particles, which have a first electrical conductivity or a first electrical resistance, and second particles, which have a second electrical conductivity or a second electrical resistance, wherein the first electrical conductivity or the first electrical resistance differs from the second electrical conductivity or the second electrical resistance. Thus, in particular the electrical conductivity or the electrical resistance of the resistance covering can be set by a weight fraction of the first and second particles. In this case, the weight fraction relates to the total weight of the first and second particles. The electrical conductivity and therefore the power loss of the resistance covering can be set using a mixture of first and second particles. The resistance covering can therefore be optimally adapted to the desired DC insulation system by the weight fractions of the first and second particles. In addition to a particle mixture having first and second particles, particle mixtures having multiple particles can also be used in this case.

To adapt the electrical conductivity or the electrical resistance of the resistance covering easily, the particles contain at least one dopable semiconductor material, the doping of which determines the electrical conductivity or the electrical resistance of the particles. In this case, the particles can be coated using the dopable semiconductor material. Furthermore, the dopable semiconductor material can have an electrical square resistance in the range of 1*10e3to 1*10e15 Ω depending on the doping. In this case, specifications of square resistances mean that the surface resistance was measured at a field strength of 100 V/mm. Particles having different electrical conductivities or resistances can be provided by the doping of the semiconductor material. The electrical conductivity or the resistance of the resistance coating is accordingly easily settable via the particles contained therein and can be adapted easily to the requirements in different DC insulation systems.

For example, the semiconductor material can be a metal oxide, such as tin oxide (SnO₂), zinc oxide (ZnO), zinc stannate (ZnSnO₃), titanium dioxide (TiO₂), lead oxide (PbO), or silicon carbide (SiC). Antimony (Sb), indium (In), or cadmium (Cd) are suitable as doping elements. Tin oxide (SnO₂) doped with antimony (Sb) may be used. Due to the use of the dopable semiconductor material, depending on the doping, different electrical square resistances can be implemented in the range of 1*10e3 to 1*10e15 Ω, or in the range of 1*10e11 to 1*10e15 Ω. To provide a particle having a high square resistance in the range of 1*10e11 to 1*10e15 Ω, the particles can additionally be coated with an electrically insulating layer, such as titanium dioxide (TiO₂).

In a further embodiment, the resistance covering is implemented so that it has ohmic behavior at field strengths in particular greater than 30 V/mm, greater than 100 V/mm, or even greater than 500 V/mm. That is to say, the current density of the resistance covering increases linearly with the rising field strength. Furthermore, the resistance covering can be implemented so that it has ohmic behavior in a first field strength range, in particular greater than 30 V/mm, greater than 100 V/mm, or even greater than 500 V/mm, and does not have ohmic behavior in a second field strength range, in particular greater than 30 V/mm, greater than 100 V/mm, or even greater than 500 V/mm. A resistance covering can thus be provided which has ohmic behavior, for example, only in the relevant field strength range for the respective DC insulation system. The matrix material and/or the particles can be selected accordingly to implement the resistance covering, as described above. For example, the field strength, from which the resistance covering has ohmic behavior, can be implemented by the flexibility of the matrix material at different temperatures. In addition, a predefined power loss can be implemented in a predefined field strength range by implementing the specific resistance of the resistance covering, for example, via the selection of the mixture ratio of the particles.

Furthermore, a DC insulation system having the above-described resistance covering is proposed. In this case, field strengths greater than 30 V/mm, greater than 100 V/mm, or even greater than 500 V/mm can occur in the region of the resistance covering. In one embodiment, the DC insulation system has a first conductor and a second conductor, between which, for example, electrical field strengths greater than 30 V/mm, greater than 100 V/mm, or even greater than 500 V/mm can be generated in operation of the DC insulation system.

In a further embodiment, the DC insulation system has a first conductor and a second conductor, wherein the resistance covering is arranged between the two conductors. In particular, at least one insulator having the resistance covering, which extends at least partially between the first and the second conductors, can be provided between the first and the second conductors. The resistance covering may extend from the first conductor to the second conductor. The further space between the first and second conductors can be filled with a gaseous dielectric material, such as air.

The insulator can therefore form a solid dielectric material having interfaces to a gaseous dielectric material.

The resistance covering may be arranged on those interfaces of the insulator which adjoin a gaseous dielectric material, such as air. The coating of the insulator with the resistance covering can be performed, for example, by spraying, squeegeeing, painting, immersion, or the like. Thus, the resistance covering can be applied as a lacquer to the interfaces of the insulator which contain the matrix material, the particles, and optionally a solvent.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 is a cross-section of a DC insulation system having two conductors, between which an insulator is arranged;

FIG. 2 is a cross-section of the DC insulation system according to FIG. 1, in which the insulator has a resistance covering;

FIG. 3 is a plan view of a printed circuit board as a DC insulation system having the resistance covering;

FIG. 4 is a graph of the square resistance against the field strength for resistance coverings having rigid matrix material and different particle fractions;

FIG. 5 is a schematic plan view of a resistance covering having a flexible matrix material and particles embedded therein at field strengths less than 30 V/mm;

FIG. 6 is a schematic plan view of the resistance covering of FIG. 5 at field strengths greater than 30 V/mm;

FIG. 7 is a graph of the curve of the square resistance against the field strength for resistance coverings which have different elastomers as the matrix material; and

FIG. 8 is a graph of the curve of the square resistance against the field strength for resistance covering having elastomers, which are more viscous than those of the resistance coverings from FIG. 7.

### DETAILED DESCRIPTION OF THE PREFERRED EMBODIMENT

Reference will now be made in detail to the preferred embodiments of the present invention, examples of which are illustrated in the accompanying drawings, wherein identical or functionally identical elements are provided with the same reference signs in the figures if not otherwise indicated.

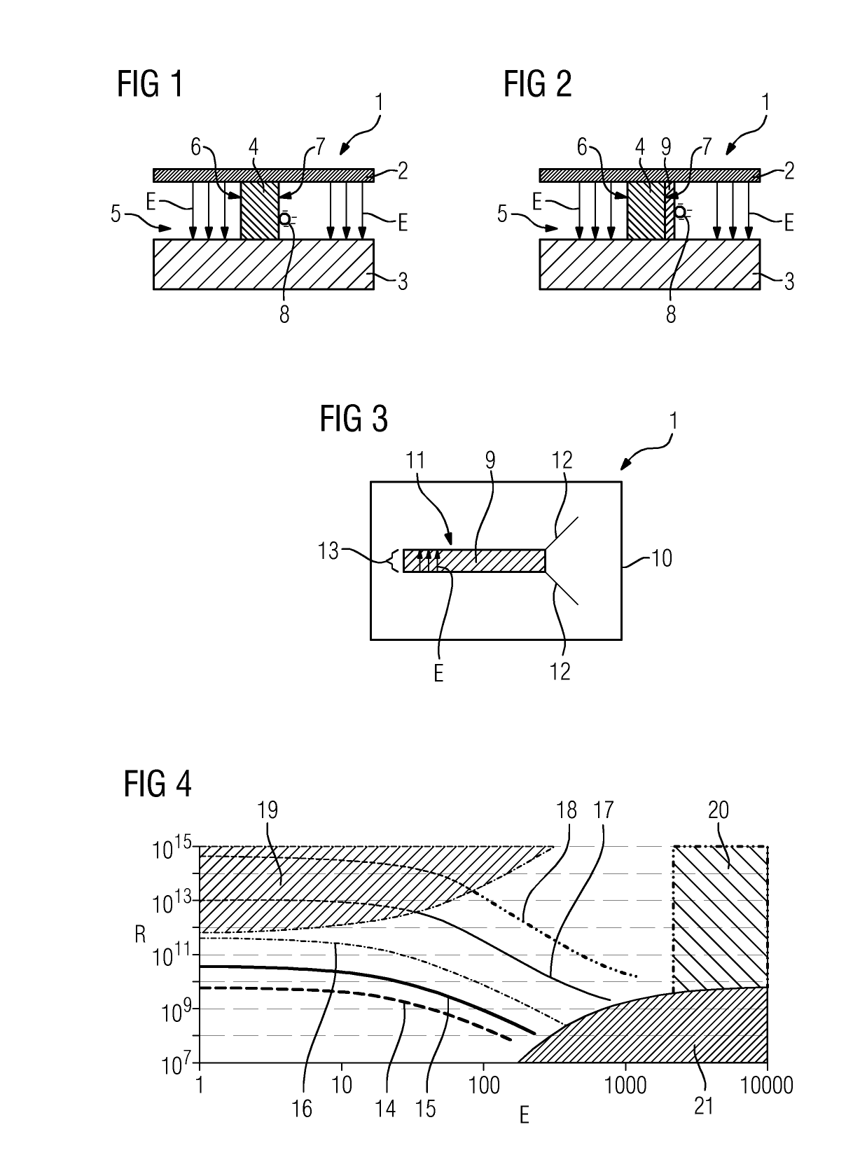

FIG. 1 shows a DC insulation system 1 having a first conductor 2, which conducts a direct current, and a second conductor 3, which is at ground potential as a neutral conductor. An electrical field E is applied between the two conductors 2, 3, which may be greater than 30 V/mm, greater than 100 V/mm, or even greater than 500 V/mm.

An insulator 4 spaces the two conductors 2, 3 apart from one another. In this case, the insulator 4 partially extends in a space 5 between the two conductors 2, 3. The further space 5 is filled with a gaseous dielectric material, such as air. Therefore, interfaces 6, 7 are formed on the insulator 4, which form a transition between the insulator 4 as a solid dielectric material and the gaseous dielectric material. Dirt particles 8 can collect on these interfaces 6, 7, which can result in excessive field increases and the thermal destruction of the insulator 4. To avoid such damage, the insulator 4 can be coated with a resistance covering 9, as shown in FIG. 2.

The configuration of FIG. 2 illustrates the use of the resistance covering 9 in the DC insulation system 1 of FIG. 1.

In this case, the insulator 4 is coated with the resistance covering 9. It is arranged on the interfaces 6, 7 (only shown as an example for the interface 7) of the insulator 4, which adjoin the gaseous dielectric material, such as air. Excessive field increases caused by dirt particles 8 can be prevented by the resistance covering 9. Thus, the insulator can be protected from electrical damage by (partial) discharges in particular at field strengths greater than 30 V/mm, greater than 100 V/mm, or even greater than 500 V/mm.

FIG. 3 shows a printed circuit board 10 having the resistance covering 9 as a further example of a DC insulation system 1 having field strengths of, for example, greater than 30 V/mm, or greater than 100 V/mm, or greater than 500 V/mm.

The printed circuit board 10 of FIG. 3 has a substrate, on which a conductor track structure 11 having conductor tracks 12, for example, is printed. To be able to construct such printed circuit boards 10 in as miniaturized a manner as possible, the conductor tracks 12 are to be provided in a high density on the substrate, without influencing the functionality. However, the closer the conductor tracks 12 are arranged to one another, the higher the electrical field strengths E become between the conductor tracks 12. Thus, the electrical field strength E between conductor tracks 12 can rise to greater than 30 V/mm, greater than 100 V/mm, or even greater than 500 V/mm. To homogenize such field strengths E over the entire spacing of the two conductors, the resistance covering 9 is provided on the insulating substrate in the region 13 between the conductor tracks 12 shown as examples in FIG. 3.

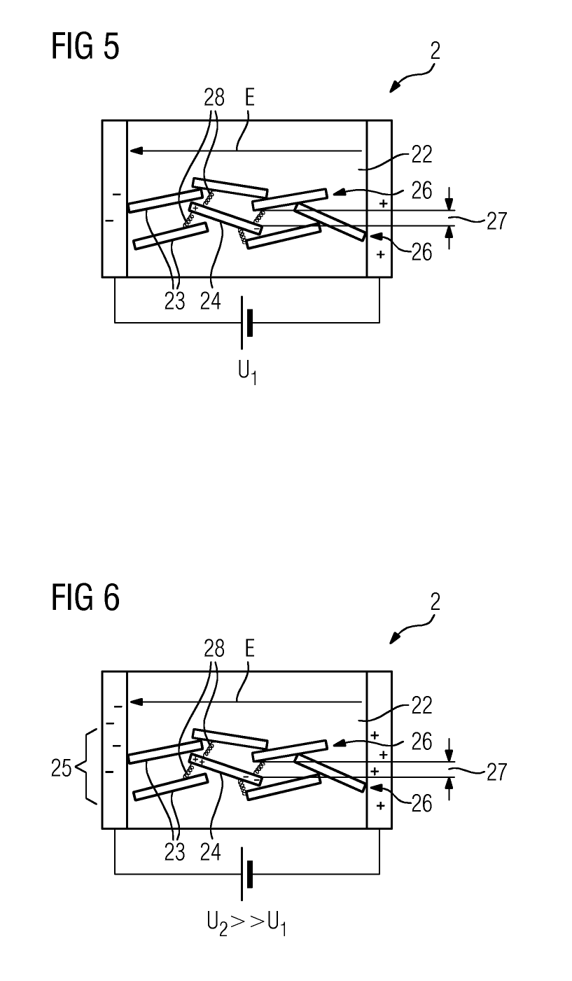

FIG. 4 shows a curve of the square resistance R against the electrical field strength E for resistance coverings 9 having rigid matrix material 22 (see FIGS. 5 and 6) and different mixture ratios of first particles 23 having a first, high resistance (also “high-resistance filler” in the present case) and particles 24 having a second, low resistance (also “low-resistance filler” in the present case). In this case, the square resistance R is indicated in ohms and the field strength E is indicated in V/mm. In the illustrated curves 14 to 18, the particle fraction of the high-resistance filler continues to increase, wherein the particle fraction of the low-resistance filler is reduced simultaneously in the same ratio (for example, in steps of 25%).

The curve 14 shows the behavior of the square resistance R against the field strength E in a resistance covering 9, which has a matrix material 22 (for example, 78 vol. %) and a low-resistance particle fraction (for example, 22 vol. %). At low field strengths E less than 10 V/mm, this resistance covering displays a constant square resistance R of approximately 1*10e10 Ω. The square resistance R decreases from a field strength E of approximately 10 V/mm. The resistance covering 9 therefore displays non-ohmic behavior from approximately 10 V/mm, wherein the square resistance R decreases with increasing field strength E and the current density increases accordingly.

The curve 15 shows the behavior of the square resistance R against the field strength E in the case of a resistance covering 9, in which a particle fraction of the low-resistance filler of 25 wt. % was replaced by a high-resistance filler. Due to the increased particle fraction, the square resistance R is increased up to an electrical field strength E, from which the behavior deviates from the ohmic behavior. Similar behavior is shown in the curves 16, 17, 18, wherein in the case of the studied resistance coverings 9, the low-resistance particles 24 were replaced step-by-step (for example, in 25% steps) by high-resistance particles 23.

Furthermore, the operating range of the studied resistance coverings 9 is shown in FIG. 4. Thus, the current which can be measured in the resistance covering 9 is too low for measurement in the range 19 having low field strengths E and high square resistance values R. In a range 21 having low square resistance values R and high field strengths E, heating and thermal destruction of the resistance covering 9 occurs.

In a range 20 having high square resistance values R and high field strengths E, in contrast, discharges or partial discharges into air occur, which can also result in damage to the resistance covering 9.

FIG. 5 schematically shows a resistance covering 9 having a flexible matrix material 22 and particles 23, 24 embedded therein at field strengths E less than 30 V/mm. The matrix material 22 is an elastic material in particular in this case, which has a Shore hardness A of, for example, 10 to 80. Elastomers are suitable for this purpose, such as silicone rubbers or polyester imide resins.

Particles 23, 24 in the form of small plates are embedded in the matrix material 22. The particles 23, 24 are embodied in this case as coated particles 23, 24 having an aspect ratio of 10 to 100. For example, particles 23, 24 in the form of small plates, such as mica particles, which have a thickness of several hundred nanometers, for example, 350 nm, and a width or length of several micrometers, for example, 6.5 μm, are suitable. Particles 23, 24 in the form of small rods are also suitable, such as carbon nanotubes, which have, for example, a width and thickness of several nanometers and a length of several hundred nanometers.

Furthermore, the particles 23, 24 may be coated with a doped semiconductor material, such as tin oxide. Antimony is suitable as the doping element in this case, for example. Depending on the doping of the semiconductor material, with which the particles 23, 24 are coated, different electrical conductivities or resistances result for the particles 23, 24. Thus, the resistance coating 9 can have different particles 23, 24 or a particle mixture, via which the resistance or the conductivity of the resistance covering 9 can be adapted easily to the respective application.

The particles 23, 24 are furthermore arranged in multiple particle layers 26. In this case, the particles 23, 24 are aligned along the larger dimension thereof, i.e., in the case of particles 23, 24 in the form of small plates along the larger surface and in the case of particles 23, 24 in the form of small rods along the larger axis. In addition, the particles 23, 24 of adjacent layers 26 at least partially overlap.

In FIG. 5, the resistance covering 9 is subjected to low field strengths E of, for example, less than 30 V/mm. FIG. 6 schematically shows the resistance covering 9 at field strengths E, for example, greater than 30 V/mm, greater than 100 V/mm, or even greater than 500 V/mm.

For illustrative purposes, a particle 24 which aligns itself at higher field strengths is shown in FIGS. 5 and 6. The particle 24 is more strongly polarized in FIG. 6 in comparison to FIG. 5, i.e., the charge displacement within the particle 24 is amplified. At high field strengths E greater than 30 V/mm, greater than 100 V/mm, or even greater than 500 V/mm and given spacing 27 in an inflexible matrix material 22, the electrons could overcome the potential barrier and the current density of the resistance covering 9 would increase disproportionally.

However, if the matrix material 22 is sufficiently flexible that the particle 24 can move, it aligns itself in relation to the adjacent particles 23 in accordance with its polarization. This is because the particles 23, 24 are polarized by the application of a constant voltage U₂ >>U₁ to the resistance covering 9. A torque acts on the particles 23, 24 in dependence on the aspect ratio of the particles 23, 24, the conductivity of the particles 23, 24, and the applied field strength. In the case of a flexible matrix material 22, hardly any force counteracts the torque of the particles 23, 24 and the particles 23, 24 can align themselves in the field. This flexibility of the matrix material 22 and the mobility of the particles 23, 24 resulting therefrom is indicated in FIGS. 5 and 6 with the springs 28 between the particle 24 and the adjacent particles 23.

The spacing 27 to adjacent particles 23 and the potential barrier resulting therefrom are increased by the alignment of the particle 24. The electrons can no longer tunnel and a leakage current flows, which is reflected in ohmic resistance behavior. The breakdown voltage of the resistance covering 9 therefore shifts toward higher field strengths E, and the resistance covering 9 also has ohmic behavior at field strengths E greater than 30 V/mm, greater than 100 V/mm, or even greater than 500 V/mm.

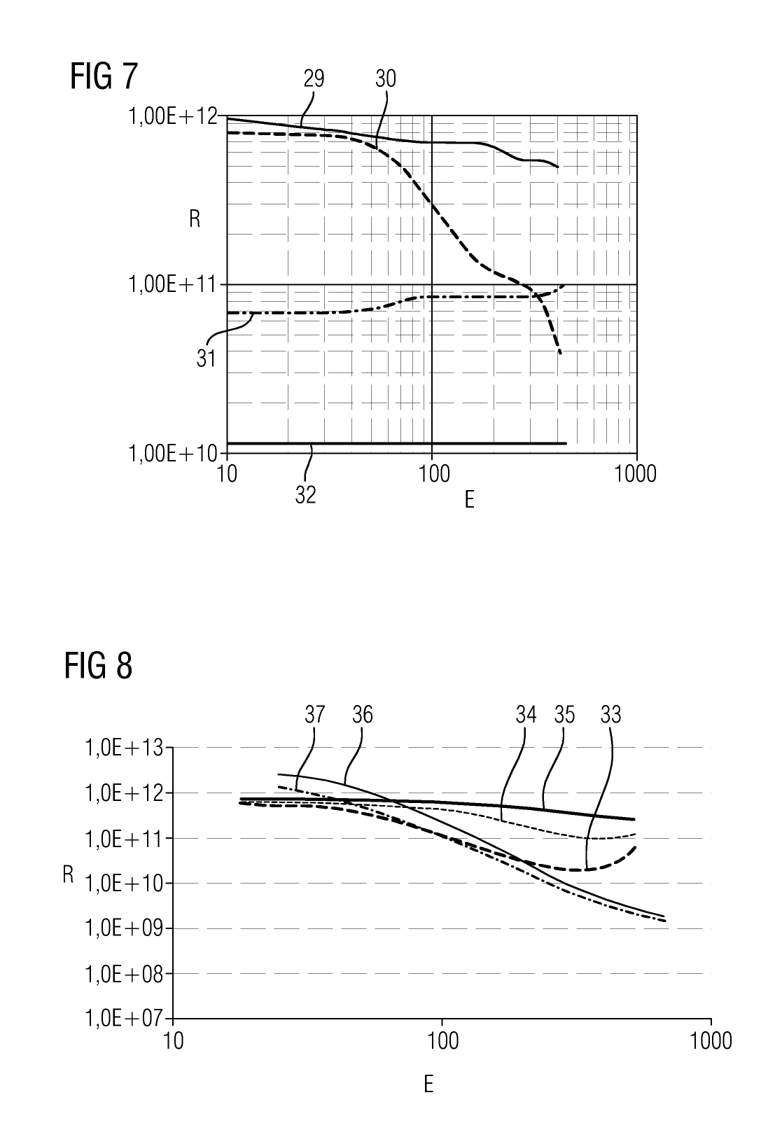

FIG. 7 shows the curve of the square resistance R against the field strength E for resistance coverings 9, using different elastomers as the matrix material 22.

The studied resistance coverings 9 contain, in relation to the total volume, a volume fraction of 22 vol. % of particles 23, 24 having a square resistance R of 1*10e12 Ω. The composition of the elastomers 22, in which the particles 23, 24 are embedded, is based on silicone rubber, which has a Shore hardness A between 37 and 45. The curve 29 represents the behavior of the resistance covering 2, which contains a silicone rubber having Shore hardness A 45, at room temperature. The curve 31 represents the behavior of the resistance covering 2, which contains a further silicone rubber having Shore hardness A 37, at room temperature. The curve 32 represents the behavior of the resistance covering 2, which contains a further silicone rubber having Shore hardness A 45, at room temperature. The different resistance values R result in this case from the different starting monomers which are contained in the matrix material 22.

FIG. 7 shows that resistance coverings 9 having a flexible matrix material 22 have ohmic behavior over a broad field strength range E of 10 to 500 V/mm.

In addition, the curve 30 shows the behavior of the square resistance R against the field strength E, wherein nonconductive beads are also embedded in the matrix material 22 having a Shore hardness A of 45, in addition to the particles 23, 24. The alignment of the particles 23, 24 in the matrix material 22 is thus suppressed. The curve 30 therefore already displays non-ohmic behavior at several tens of volts per millimeter. The capability of the particles 23, 24 to align themselves is thus decisive to also achieve the desired ohmic behavior at high field strengths.

FIG. 8 shows the curve of the square resistance R against the field strength E for resistance coverings 9 having an elastomer which is more viscous than the elastomers from FIG. 7.

The studied resistance coverings 9 contain, in relation to the total volume, a volume fraction of 22 vol. % of particles 23, 24 having a square resistance R of 1*10e12 Ω. The composition of the elastomer is based on a polyester imide resin, which has a Shore hardness between 45 and 80. In this measurement, the curves were recorded at different times for the same resistance covering 9. Thus, the measurement of the curve 33 of the square resistance R was started with application of the electrical field. It can be seen here that the ohmic behavior first results at higher field strengths E in the range of 500 V/mm. The particles 23, 24 thus only align themselves slowly, because the elastomer based on polyester imide resin is more viscous than elastomers based on silicone rubber.

After a time of 24 hours, the same sample was measured once again (curve 34). In this case, it was shown that the alignment of the particles 23, 24 was still partially present. The relaxation therefore takes place more slowly in the polyester imide resin. A further measurement after 5 minutes using the same sample resulted in curve 35, which shows that the particles 23, 25 have not relaxed in such a short time and have maintained their alignment. The curves 36 and 37 were recorded using an increased particle content and show that the resistance covering 9 does not have ohmic behavior from 500 V/mm if the particles 23, 24 cannot align themselves.

Although the invention was described in the present case on the basis of various exemplary embodiments, it is not restricted thereto, but rather is modifiable in manifold ways.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-15. (canceled)

16. A resistance covering for a DC insulation system, comprising:
a flexible matrix material having particles embedded therein, the particles having an aspect ratio greater than 1, the particles aligning themselves in dependence on an electrical field strength.

17. The resistance covering as claimed in claim 16, wherein the matrix material is an elastomer.

18. The resistance covering as claimed in claim 16, wherein the matrix material has a Shore hardness A of 10 to 90.

19. The resistance covering as claimed in claim 16, wherein the particles are at least one of small plates and small rods.

20. The resistance covering as claimed in claim 16, wherein the particles are selected from the group consisting of mica particles, silicon carbide particles, metal oxide particles, and carbon nanotubes.

21. The resistance covering as claimed in claim 16, wherein one of a volume fraction and an aspect ratio of the particles is selected so that a percolation threshold is exceeded.

22. The resistance covering as claimed in claim 16, wherein a volume fraction of the particles is between 5 and 55 percent by volume.

23. The resistance covering as claimed in claim 16, wherein the matrix material contains first particles, which have a first electrical resistance, and second particles, which have a second electrical resistance, wherein the first electrical resistance differs from the second electrical resistance, and wherein an electrical resistance of the resistance covering is determined by a weight fraction of the first and second particles.

24. The resistance covering as claimed in claim 16, wherein the particles contain at least one dopable semiconductor material having a doping that determines an electrical resistance of the particles.

25. The resistance covering as claimed in claim 24, wherein the dopable semiconductor material has an electrical square resistance between 1*10e3 and 1*10e15 Ω.

26. The resistance covering as claimed in claim 24, wherein the dopable semiconductor material is a metal oxide.

27. The resistance covering as claimed in claim 16, wherein the resistance covering has ohmic behavior in a first field strength range and has non-ohmic behavior in a second field strength range.

28. A DC insulation system comprising:
a resistance covering formed of a flexible matrix material having particles embedded therein, the particles having an aspect ratio greater than 1, the particles aligning themselves in dependence on an electrical field strength.

29. The DC insulation system as claimed in claim 28,
further comprising first and second conductors,
wherein the resistance covering is arranged between the first and the second conductors.

30. The DC insulation system as claimed in claim 29, further comprising at least one insulator having the resistance covering, which at least partially extends between the first and the second conductors, provided between the first and the second conductors.
